(19) United States
(12) Patent Application Publication
(10) Pub. No.: US 2006/0123415 A1
(43) Pub. Date: Jun. 8, 2006

(54) System for distributing middleware applications on information handling system

(76) Inventors: Shree A. Dandekar, Round Rock, TX (US); Bruce A. Zabava, Pflugerville, TX (US); Jeremy R. Ziegler, Pflugerville, TX (US)

Correspondence Address: HAMILTON & TERRILE, LLP, P.O. BOX 203518, AUSTIN, TX, 78720, US

(21) Appl. No.: 11/004,695

(22) Filed: Dec. 3, 2004

(51) Int. Cl. G06F 9/445; G06F 9/44

(52) U.S. Cl. 717/177; 717/172

(57) ABSTRACT

A method for distributing middleware applications onto an information handling system having a plurality of installed components. The method includes selecting a preferred version of a middleware application based upon the plurality of installed components on the information handling system and installing the preferred version of the middleware application.

### BACKGROUND OF THE INVENTION

1. Field of the Invention

The present invention relates to build to order systems, and more particularly, to distributing middleware applications on information handling systems.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

It is known to manufacture information handling systems based on a build to order process that allows a customer to specify specific hardware and software options. In general, known build to order systems require a large number of disjointed, manual processes that take place for a manufacturer to successfully validate and transform third-party vendor software packages to be factory installable. This not only increases the probability of human-induced error, but dramatically increases the time required to deliver validated, installable software images to the factory environment. It is desirable for an automated system for receiving software and for generating validated, factory-installable software without direct human interaction.

Often a manufacturer preloads the operating system as well as application programs onto information handling systems based upon a customer's order. To ensure the interoperability between the operating system and the application programs, sometimes certain component applications are desirable. These component applications are referred to as middleware applications. Middleware applications are generally located between an application and an operating system, network operating system or a database management system and enable generic interoperability between certain software applications and an operating system. Examples of middleware applications include Internet Explorer application, a java virtual machine (JVM) application, a DirectX plugin application, a Flash plugin application, a Microsoft .NET framework type of application and a reader application such as the Acrobat Reader available from Adobe, Inc.

There are a plurality of issues relating to middleware applications, especially with reference to when software is preloaded onto an information handling system. For example, when middleware components are changed among different applications and hardware installs in a build to order model, it may be difficult for a manufacturer to know which versions of a middleware application are present on a particular final install image. Often there are no logs, tools or markers that allow a manufacturer to review what was installed to understand which version of a middleware application is present on a particular information handing system.

Also for example, due to an emphasis on security, there are many security patches that are generated for middleware applications. However, often these patches might not install across all versions of a particular middleware application. A particular patch might only apply to a specific version of a middleware application. For example, security patches and/or software updates are needed for a specific Internet Explorer middleware version to install specific content on a particular information handling system.

Also, for example, with a DirectX plugin application, it is desirable to know which particular version of the DirectX plugin is present on a particular information handling system before certain application patches can be installed. Also, for example, with a DirectX plugin application, it is desirable to have an understanding of the device driver minimum DirectX requirements for optimum performance of a particular information handling system, so that an appropriate DirectX version can be installed on the information handling system during a build to order manufacturing process.

### SUMMARY OF THE INVENTION

In accordance with the present invention, a method for distributing middleware applications is set forth that includes dynamic logic for selecting a suitable version of a middleware application that is executed during a software install process. The method for distributing middleware applications addresses conflict management of different versions of middleware applications that are to be installed on a particular information handling system. The method for distributing middleware applications provides a standard for allowing a manufactured to understand a version of middleware that stored within a final install image. The method allows for leveraging in patch mechanisms so that security updates can be intelligently installed onto appropriate versions of a middleware application.

More specifically, the method for distributing middleware applications is based on information part numbers as well as a base installer SRV. The base installer SRV includes information specific a particular information handling system regarding which middleware applications are installed on the particular information handling system and the information part number provides information regarding a version of each particular middleware application. The information part numbers in the SDR, used in conjunction with an understanding of a manufacturer installation process, provides a clear understanding of the version of the middleware application that is associated with a particular information handling system. Also, the information part numbers and the manufacturer installation process can be leveraged during security patch installs to allow for proper installation of the security patches.

In one embodiment, the invention relates to a method for distributing middleware applications onto an information handling system having a plurality of installed components. The method includes selecting a preferred version of a middleware application based upon the plurality of installed components on the information handling system and installing the preferred version of the middleware application.

In another embodiment, the invention relates to an apparatus for distributing middleware applications onto an information handling system having a plurality of installed components. The apparatus includes means for selecting a preferred version of a middleware application based upon the plurality of installed components on the information handling system and means for installing the preferred version of the middleware application.

In another embodiment, the invention relates to a system for distributing middleware applications onto an information handling system having a plurality of installed components. The system includes a selecting module and an installing module. The selecting module selects a preferred version of a middleware application based upon the plurality of installed components on the information handling system. The installing module installs the preferred version of the middleware application.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows an example of an automated build to order system for installing software on an information handling system.

FIG. 2 is a system block diagram of an information handling system.

FIG. 3 shows a flow chart for a method for distributing middleware applications.

FIG. 4 shows a flow chart for another method for distributing middle ware applications.

FIG. 5 shows a block diagram of an example of identifying preferred middleware applications from a plurality of middleware applications.

### DETAILED DESCRIPTION

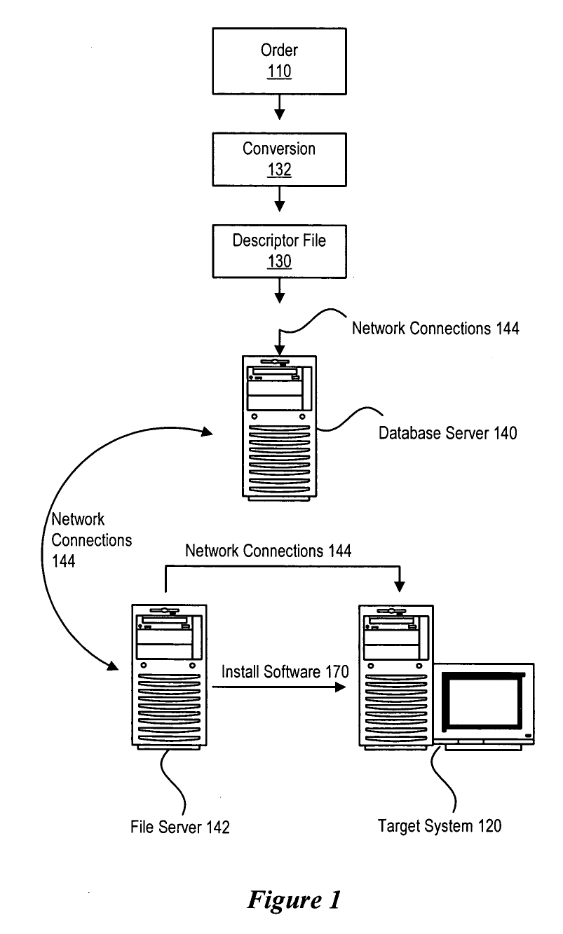

Referring to FIG. 1, a schematic diagram of a software installation system 100 at an information handling system manufacturing site is shown. In operation, an order 110 is placed to purchase a target information handling system 120. The target information handling system 120 to be manufactured contains a plurality of hardware and software components. For instance, target information handling system 120 might include a certain brand of hard drive, a particular type of monitor, a certain brand of processor, and software. The software includes a particular version of an operating system along with all appropriate driver software and other application software along with appropriate software bug fixes. The software also includes middleware applications as appropriate for the operating system and application software.

Before the target information handling system 120 is shipped to the customer, the plurality of components are installed and tested from, for example, a fixed image of the software. Such software installation and testing advantageously ensures a reliable, working information handling system which is ready to operate when received by a customer.

Because different families of information handling systems and different individual computer components require different software installation, it is necessary to determine which software to install on a target information handling system 120. A descriptor file 130 is provided by converting an order 110, which corresponds to a desired information handling system having desired components, into a computer readable format via conversion module 132. In one embodiment, the descriptor file 130 is a system descriptor record (SDR) file. The SDR file is a resource allocation file that includes text of which components are included within a particular information handling system.

Component descriptors are computer readable descriptions of the components of target information handling system 120 which components are defined by the order 110. In a preferred embodiment, the component descriptors are included in a descriptor file called a system descriptor record which is a computer readable file containing a listing of the components, both hardware and software, to be installed onto target information handling system 120. Having read the plurality of component descriptors, database server 140 provides a plurality of software components corresponding to the component descriptors to file server 142 over network connection 144. Network connections 144 may be any network connection well-known in the art, such as a local area network, an intranet, or the internet. The information contained in database server 140 is often updated such that the database contains a new factory build environment. The software is then installed on the target information handling system 120. The software installation is controlled by a software installation management server that is operable to control the installation of the operating system and other software packages specified by a customer.

The software installation includes a system for distributing middleware applications that selects a suitable version of a middleware application. The system for distributing middleware applications addresses conflict management of different versions of middleware applications that are to be installed on a particular information handling system.

More specifically, the system for distributing middleware applications is based on information part numbers as well as a base installer SRV. The base installer SRV includes information specific a particular information handling system regarding which middleware applications are installed on the particular information handling system and the information part number provides information regarding a version of each particular middleware application. The information part numbers in the SDR, used in conjunction with an understanding of a manufacturer installation process, provides a clear understanding of the version of the middleware application that is associated with a particular information handling system. Also, the information part numbers and the manufacturer installation process can be leveraged during security patch installs to allow for proper installation of the security patches.

The system for distributing middleware applications installs the appropriate versions of one or more middleware applications based upon the particular information handling system. These middleware applications may include a correct version of a java virtual machine, a correct version of a DirectX application as determined by a highest demanding driver, a correct version of operating system security update (including patches) based upon a version of an installed explorer application, a correct version of security update (including patches) based upon a version of an installed net framework installed, a correct version of an installer application as determined by a highest demanding application, a correct version of a reader update based upon a version of an installed reader and a correct version of a flash player as determined by a highest demanding application.

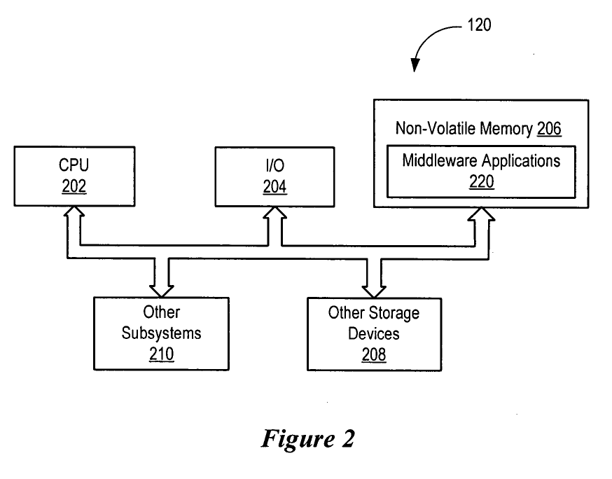

Referring to FIG. 2, a block diagram of an information handling system, such as the target information handling system 120 is shown. The information handling system includes a processor 202, input/output (I/O) devices 204, such as a display, a keyboard, a mouse, and associated controllers, non volatile memory 206 such as a hard disk drive, and other storage devices 208, such as a floppy disk and drive and other memory devices, and various other subsystems 210, all interconnected via one or more buses 212. The software is installed onto the non volatile memory 206. Alternately, the software may be installed onto any appropriate non-volatile memory. The non-volatile memory 206 may also store the middleware applications 220.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

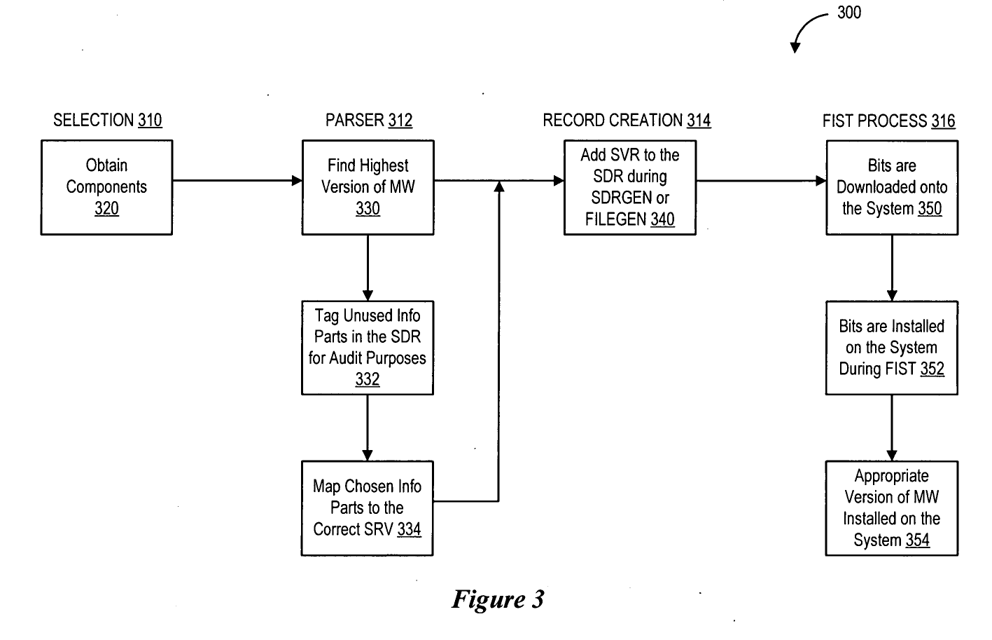

Referring to FIG. 3, a flow chart for a operation of a system for distributing middleware applications is shown. In general, the system 300 executes a program during factory download that places specific middleware applications on the information handling system 120 based on predefined criteria such as information part numbers. Such a system 300 allows a manufacturer to have flexibility in adding or modifying which middleware applications are added to a particular information handling system 200. The system 300 includes a selection portion 310, a parser portion 312, a recorder creation portion 314 and a Factory Installation System Test (FIST) portion 316. FIST is the process of starting the target information handling system, after the software download, to install all drivers and applications.

When operating within the selection portion 310, the system 300 obtains particular components as identified by particular information part definitions for a particular information handling system at step 320 based upon a system descriptor record (SDR) for the particular information handling system.

Next, during a parser portion 312, the system 300 determines a highest version of a middleware application at step 330. Next, the system 300 identifies unused information part numbers within the system descriptor record (SDR) for audit purposes at step 332. (An audit might be performed, for example, during testing prior to release of a new product.) Next the system 300 maps the selected information part numbers to the appropriate software recovery vehicle (SRV) at step 334.

Next during the record creation portion 314, the system 300 adds an SRV to the SDR file during a SDR generation (SDRGEN) operation or a file generation (FILEGEN) operation at step 340.

Next, during the FIST portion 316, the system 300 downloads the identified middleware applications onto the target information handling system 120 at step 350. Next the middleware application is installed onto the target information handling system 120 during the FIST process at step 352. Next the appropriate version of the middleware application is installed onto the target information handling system at step 354.

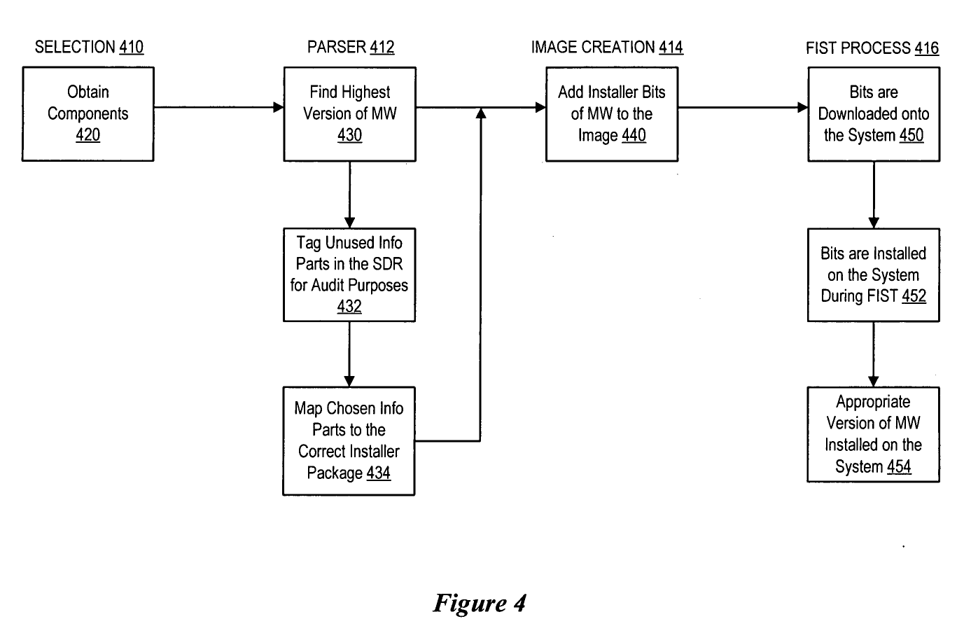

FIG. 4 shows a flow chart for another method for distributing middleware applications which is used when creating a fixed image of a software install. In general, the system 400 executes a program during factory download that places specific middleware applications on the information handling system 120 based on predefined criteria such as information part numbers. Such a system 400 allows a manufacturer to have flexibility in adding or modifying which middleware applications are added to a particular information handling system 200. The system 400 includes a selection portion 410, a parser portion 412, a recorder creation portion 414 and a FIST portion 416.

When operating within the selection portion 410, the system 400 obtains particular components as identified by particular information part definitions for a particular information handling system at step 420 based upon a system descriptor record (SDR) for the particular information handling system.

Next, during a parser portion 412, the system 400 determines a highest version of a middleware application at step 430. Next the system 400 identifies unused information part numbers within the SDR file for audit purposes at step 432. Next, the system 400 maps the selected information part numbers to the appropriate installer package at step 434.

Next, during the image creation portion 414, the system 400 adds installer bits of the middleware applications to be installed to an image to be installed on the target information handling system at step 440.

Next, during the FIST portion 416, the system 400 downloads the bits of the installed image onto the target information handling system 120 at step 450. Next, the installer bits are installed onto the target information handling system 120 during the FIST process at step 452. Next, the appropriate version of the middleware application is installed onto the target information handling system at step 454.

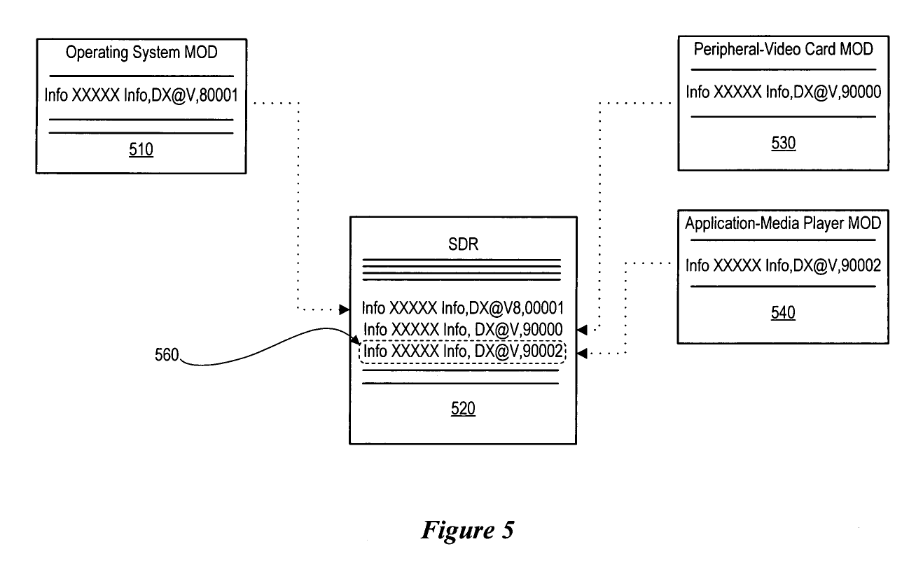

FIG. 5 shows a block diagram of an example of identifying preferred middleware applications from a plurality of middleware applications. During the software install process for a target information handling system, an operating system model 510 defines a default version of a middleware application such as a DirectX application. This information regarding the default version of the middleware application is included within the SDR file 520. Additionally each peripheral component 530 that has an associated middleware application provides this middleware application model information to the SDR file 520. Additionally, each application component 540 that has an associated middleware application provides this middleware application information to the SDR file 520.

Accordingly, various hardware and software module identifiers (MODs) populate the SDR file 520 with all requests for the various versions of the middleware applications that are identified for software install on the target information handling system. Next, the system for distributing middleware applications 300 reviews the SDR file 520 and identifies the highest or most recent version of the particular middleware application requested. The system 300 then installs this version of the middleware application onto the target information handling system.

### OTHER EMBODIMENTS

Other embodiments are within the following claims.

For example, while specific middleware applications are identified, other middleware applications are also contemplated.

Also for example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A method for distributing middleware applications onto an information handling system having a plurality of installed components, the method comprising:
selecting a preferred version of a middleware application based upon the plurality of installed components on the information handling system;
installing the preferred version of the middleware application.

2. The method of claim 1, wherein
the plurality of installed components are determined based upon system descriptor record.

3. The method of claim 1, wherein
the plurality of installed components each include a corresponding information part number designation.

4. The method of claim 1, wherein
each of the plurality of installed components include a corresponding version of a middleware application, the corresponding version of the middleware application being identified within a corresponding information part number designation.

5. The method of claim 1, wherein
the selecting includes selecting a most recent version of the middleware application as the preferred version of the middleware application.

6. The method of claim 1, wherein
the installing includes installing a base middleware application as well as a most recent patch corresponding to the middleware application.

7. The method of claim 1, wherein
the preferred version of the middleware application includes at least one of a correct version of a java virtual machine, a correct version of a DirectX application, a correct version of operating system security update for an installed explorer application, a correct version of security update for an installed framework, a correct version of an installer application for a demanding application, a correct version of reader updates for an installed reader and a correct version of a flash player for a highest demanding application.

8. An apparatus for distributing middleware applications onto an information handling system having a plurality of installed components, the apparatus comprising:
means for selecting a preferred version of a middleware application based upon the plurality of installed components on the information handling system;
means for installing the preferred version of the middleware application.

9. The apparatus of claim 8, wherein
the plurality of installed components are determined based upon system descriptor record.

10. The apparatus of claim 8, wherein
the plurality of installed components each include a corresponding information part number designation.

11. The apparatus of claim 8, wherein
each of the plurality of installed components include a corresponding version of a middleware application, the corresponding version of the middleware application being identified within a corresponding information part number designation.

12. The apparatus of claim 8, wherein
the means for selecting includes means for selecting a most recent version of the middleware application as the preferred version of the middleware application.

13. The apparatus of claim 8, wherein
the means for installing includes means for installing a base middleware application as well as a most recent patch corresponding to the middleware application.

14. The apparatus of claim 8, wherein
the preferred version of the middleware application includes at least one of a correct version of a java virtual machine, a correct version of a DirectX application, a correct version of operating system security update for an installed explorer application, a correct version of security update for an installed framework, a correct version of an installer application for a demanding application, a correct version of reader updates for an installed reader and a correct version of a flash player for a highest demanding application.

15. A system for distributing middleware applications onto an information handling system having a plurality of installed components, the system comprising:
a selecting module, the selecting module selecting a preferred version of a middleware application based upon the plurality of installed components on the information handling system;
an installing module, the installing module installing the preferred version of the middleware application.

16. The system of claim 15, wherein
the plurality of installed components are determined based upon system descriptor record.

17. The system of claim 15, wherein
the plurality of installed components each include a corresponding information part number designation.

18. The system of claim 15, wherein
each of the plurality of installed components include a corresponding version of a middleware application, the corresponding version of the middleware application being identified within a corresponding information part number designation.

19. The system of claim 15, wherein
the selecting module selects a most recent version of the middleware application as the preferred version of the middleware application.

20. The system of claim 15, wherein
the installing module installs a base middleware application as well as a most recent patch corresponding to the middleware application.

21. The system of claim 15, wherein
the preferred version of the middleware application includes at least one of a correct version of a java virtual machine, a correct version of a DirectX application, a correct version of operating system security update for an installed explorer application, a correct version of security update for an installed framework, a correct version of an installer application for a demanding application, a correct version of reader updates for an installed reader and a correct version of a flash player for a highest demanding application.
